(19) United States
(12) Patent Application Publication
(10) Pub. No.: US 2020/0281238 A1
(43) Pub. Date: Sep. 10, 2020

(54) JERKY-CONTAINING FOOD PRODUCT

(71) Applicant: PREMIER NUTRITION CORPORATION, Emeryville, CA (US)

(72) Inventors: William LONG, Emeryville, CA (US); Nicole WINDSOR, Emeryville, CA (US); Ryan LUJAN, Emeryville, CA (US)

(21) Appl. No.: 16/652,453

(22) PCT Filed: Oct. 2, 2018
(86) PCT No.: PCT/US18/53957

§ 371 Date: Mar. 31, 2020

Related U.S. Application Data
(60) Provisional application No. 62/566,931, filed on Oct. 2, 2017.
(60) Provisional application No. 62/712,694, filed on Jul. 31, 2018.

(51) Int. Cl. A23L 13/10; A23L 25/00; A23L 29/30; A23L 29/212; A23L 33/185; A23L 33/115; A23P 20/10

(52) U.S. Cl. CPC A23L 13/10; A23L 25/00; A23L 29/30; A23P 20/10; A23L 33/185; A23L 33/115; A23L 29/212

(57) ABSTRACT

A dried meat-containing shaped food product, the food product comprising: dry ingredients at an amount in the range of about 60 wt % to about 90 wt % of the food product and a binder at an amount in the range of about 10 wt % to about 40 wt % of the food product. The dry ingredients comprise: a dried meat component comprising pieces of dried meat or plant protein, wherein the dried meat component is at amount in the range of about 1 wt % to about 55 wt % of the dry ingredients; and a solid nut component comprising seeds, nuts and/or legumes, and/or pieces thereof, wherein the solid nut component is at an amount in the range of about 25 wt % to about 90 wt % of the dry ingredients. The binder comprises a saccharide syrup component having a Brix of at least 80. The binder adheres the dry ingredients together resists the migration of moisture between the dry ingredients thereby providing the food product a shelf-stable structure and providing the solid nut component a shelf-stable, dry-crunchy texture.

### FIELD OF THE INVENTION

The present disclosure generally relates to a food product. More particularly, the disclosure is directed to a ready-to-eat food product that is often packaged in a single serving size for convenience of the consumer especially for consumption during exercise.

### BACKGROUND OF INVENTION

There is consumer desire for food products, including exercise-related food products that comprise a higher protein level and lower carbohydrate level than compared to conventional convenience food products such as chips, crackers, and candy bars. Additionally, there is a desire for food products that are less “processed” or contain less “processed” ingredients than such conventional food products. In particular, there is a desire for food products that comprise nuts, seeds, and dried meat or jerky like a “trail mix.” Trail mix-type products, however, are generally not considered by consumers to be convenient for eating during exercise or while “on the go.” Thus, there have been products in the form of bars that comprise (a) nuts and seeds or (b) dried fruit and dried meat, but there have not been products that combine nuts and/or seeds and dried meat that are desirable to consumers. The lack of desirability of products combining nuts/seed and jerky is due to a general incompatibility of these ingredients over extended periods. Specifically, the presence of dried meat or jerky, which contains a significant amount of moisture, tends to soften seeds and nuts due to moisture migration from the jerky. Consumers typically view this moist and soft texture change of the seeds and nuts negatively. Consumers typically prefer nuts and seeds to have a dry and crunchy texture. Additionally, such products have not exhibited a shelf-stable structure upon being stored for an extended period (e.g., one year). Specifically, such products tend to disintegrate (i.e., the ingredients tend to separate) over time due to the moisture migration.

In view of the foregoing, a need exists for a food product (e.g., a bar or cluster) that comprise nuts and/or seeds and jerky that has a shelf-stable structure and for which the nuts and/or seeds have a dry and crunchy (dry-crunchy) texture.

### SUMMARY OF INVENTION

An embodiment of the invention is directed to a dried meat-containing shaped food product, the food product comprising:
(a) dry ingredients at an amount in the range of about 60 wt % to about 90 wt % of the food product, wherein the dry ingredients comprise:
   (i) a dried meat component comprising pieces of dried meat or plant protein, wherein the dried meat component is at amount in the range of about 1 wt % to about 55 wt % of the dry ingredients; and
   (ii) a solid nut component comprising seeds, nuts and/or legumes, and/or pieces thereof, wherein the solid nut component is at an amount in the range of about 25 wt % to about 90 wt % of the dry ingredients; and
(b) a binder at an amount in the range of about 10 wt % to about 40 wt % of the food product, wherein the binder comprises a saccharide syrup component having a Brix of at least 80, and wherein the binder adheres the dry ingredients together and resists the migration of moisture between the dry ingredients thereby providing:
   (i) a shelf-stable structure to the food product, wherein a shelf-stable structure is one in which, at the one-year anniversary of the food product being made and placed in a sealed container or package, the shape of the food product is maintained with the dry ingredients remaining adhered together without separation of the binder and the dry ingredients; and
   (ii) a shelf-stable, dry-crunchy texture to the solid nut component, wherein the shelf-stable, dry-crunchy texture is one in which, at the one-year anniversary of the food product being made and placed in a sealed container or package, the food product has a water activity, a_{w}, that is in a range of about 0.35 to about 0.69.

Another embodiment of the invention is directed to a method of making a dried meat-containing shaped food product, the method comprising:

forming a mixture that comprises:
(a) dry ingredients at an amount in the range of about 60 wt % to about 90 wt % of the mixture, wherein the dry ingredients comprise:
   (i) a dried meat component comprising pieces dried meat, wherein the dried meat component is at amount in the range of about 1 wt % to about 55 wt % of the dry ingredients; and
   (ii) a solid nut component comprising seeds, nuts and/or legumes, and/or pieces thereof, wherein the solid nut component is at an amount in the range of about 25 wt % to about 90 wt % of the dry ingredients; and
(b) a binder at an amount in the range of about 10 wt % to about 40 wt % of the food product, wherein the binder comprises a saccharide syrup component and has a Brix of at least 80; and

shaping the mixture and baking the shaped mixture, or baking the mixture and shaping the baked mixture, wherein the baking results in the binder adhering the dry ingredients together and resisting the migration of moisture between the dry ingredients, thereby resulting in the dried meat-containing shaped food product, wherein:
the food product has a shelf-stable structure, wherein a shelf-stable structure is one in which, at the one-year anniversary of the food product being made and placed in a sealed container or package, the shape of the food product is maintained with the dry ingredients remaining adhered together without separation of the binder and the dry ingredients; and

the solid nut component has a shelf-stable, dry-crunchy texture, wherein a shelf-stable, dry-crunchy texture is one in which, at the one-year anniversary of the food product being made and placed in a sealed container or package, the food product has a water activity, a_{w}, that is in a range of about 0.35 to about 0.69.

A further embodiment of the invention is directed to a method of making a dried meat-containing shaped food product, the method comprising:

forming a mixture that comprises:
(c) dry ingredients at an amount in the range of about 60 wt % to about 90 wt % of the mixture, wherein the dry ingredients comprise:
   (i) a dried meat component comprising pieces dried meat, wherein the dried meat component is at amount in the range of about 1 wt % to about 55 wt % of the dry ingredients; and
   (ii) a solid nut component comprising seeds, nuts and/or legumes, and/or pieces thereof, wherein the solid nut component is at an amount in the range of about 25 wt % to about 90 wt % of the dry ingredients; and
(d) a binder at an amount in the range of about 10 wt % to about 40 wt % of the food product, wherein the binder comprises a saccharide syrup component and has a Brix of at least 80; and

shaping the mixture thereby resulting in the dried meat-containing shaped food product, wherein the binder adheres the dry ingredients together and resists the migration of moisture between the dry ingredients, wherein:
the food product has a shelf-stable structure, wherein a shelf-stable structure is one in which, at the one-year anniversary of the food product being made and placed in a sealed container or package, the shape of the food product is maintained with the dry ingredients remaining adhered together without separation of the binder and the dry ingredients; and

the solid nut component has a shelf-stable, dry-crunchy texture, wherein the shelf-stable, dry-crunchy texture is one in which, at the one-year anniversary of the food product being made and placed in a sealed container or package, the food product has a water activity, a_{w}, that is in a range of about 0.35 to about 0.69.

### DETAILED DESCRIPTION OF INVENTION

One embodiment of the present invention is directed a dried meat-containing shaped food product that contains seeds, nuts, or legumes, or pieces thereof (which may referred to herein collectively as a “solid nut component” in contrast to spreads or “butter” formed from such seeds, nuts, or legumes) in addition to dried meat or jerky, wherein the product that has a shelf-stable structure and the solid nut component has a shelf-stable, dry-crunchy texture. The above-described problem of moisture migration and its negative effects on structure and texture are believed to be alieved, at least in part, by utilizing a binder for binding the dry ingredient together that resists the migration of moisture between the dry ingredients thereby providing the food product a shelf-stable structure with a solid nut component that has a shelf-stable, dry-crunchy texture.

As used herein, a food product having a “shelf-stable structure” means that the food product, at the one-year anniversary of the food product being made and placed in a sealed container or package, the shape of the food product is maintained with the dry ingredients remaining adhered together without separation of the binder and the dry ingredients.

As used herein, a food product comprising a solid nut component having a “shelf-stable, dry-crunchy texture” means that the food product, at the one-year anniversary of the food product being made and placed in a sealed container or package, has a water activity, a_{w}, that is in a range of about 0.35 to about 0.69. In certain embodiments, the food product may have a water activity that is in narrower range within the above, broadest range. For example, a dried meat-containing shaped food product may have a water activity, a_{w}, that is in a range of about 0.40 to about 0.65. In other embodiments, a dried meat-containing shaped food product has a water activity, a_{w}, that is in a range of about 0.50 to about 0.60.

The above-described dried meat-containing shaped food product is achieved by selecting particular ingredients that have certain characteristics and by including them in certain amounts as described in greater detail below. For example, it is advisable to control the relative amounts of dry ingredients and the binder.

### Dry Ingredients

The dried meat-containing shaped food product comprises dry ingredients at an amount in a range of about 60 wt % to about 90 wt % of the food product. In some embodiments, one or more of the dry ingredients may be roasted.

Dried Meat Component

The dry ingredients comprise a dried meat component comprising pieces of dried meat or plant protein, wherein the dried meat component is at amount in a range of about 1 wt % to about 55 wt % of the dry ingredients. Examples of meat or plant protein of the dried meat component include beef, fish, shellfish, poultry, pork, wild game (e.g., deer/venison, elk, boar, duck, antelope, bison, bear, turkey, pheasant, quail, salmon, alligator, buffalo, ostrich, trout, tuna, yak, kangaroo), tofu, and combinations thereof.

In some embodiments, the amount of the dried meat component is in a range of about 10 wt % to about 50 wt % of the dry ingredients.

In some embodiments, the amount of the dried meat component is in a range of about 10 wt % to about 30 wt % of the dry ingredients.

In some embodiments, the amount of the dried meat component is in a range of about 15 wt % to about 20 wt % of the dry ingredients.

Solid Nut Component

The dry ingredients comprise a solid nut component comprising seeds, nuts and/or legumes, and/or pieces thereof, wherein the solid nut component is at an amount in a range of about 25 wt % to about 90 wt % of the dry ingredients. Examples of seeds of the solid nut component include pumpkin, sesame, sunflower, watermelon, poppy, flax, quinoa, hemp, chia, pomegranate, pine nut, and combinations thereof. Examples of nuts and legumes of the solid nut component include peanut, cashew, almond, pistachio, walnut, pecan, Brazil nut, hazelnut, chestnut, macadamia, coconut, pine nut, chickpea and combinations thereof.

In some embodiments, the amount of the solid nut component is in a range of about 35 wt % to about 80 wt % of the dry ingredients.

In some embodiments, the amount of the solid nut component is in a range of about 45 wt % to about 70 wt % of the dry ingredients.

In some embodiments, the solid nut component comprises both (a) nuts and/or legumes, and/or pieces thereof and (b) seeds and/or pieces thereof.

In some embodiments, the solid nut component comprises: (a) nuts and/or legumes, and/or pieces thereof at an amount in a range of about 20 wt % to about 80 wt % of the dry ingredients; and (b) seeds and/or pieces thereof, wherein the seed component is at an amount in a range of 5 wt % to about 50 wt % of the dry ingredients. In some embodiments, the amount of the nuts and/or legumes or pieces thereof is in a range of about 30 wt % to about 70 wt % of the dry ingredients; and the amount of the seeds and/or pieces thereof is in a range of 5 wt % to about 25 wt % of the dry ingredients. In some embodiments, the amount of the nuts and/or legumes, and/or pieces thereof is in a range of about 40 wt % to about 55 wt % of the dry ingredients; and the amount of the seeds and/or pieces thereof is in a range of about 5 wt % to about 15 wt % of the dry ingredients.

Seasoninq Component

The dry ingredients of the dried meat-containing shaped food product may also comprise a seasoning component comprising particles selected from the group consisting of salt, herbs, spices, and combinations thereof, wherein the seasoning component is at amount in a range of about 0.5 wt % to about 6 wt % of the dry ingredients. Examples of herbs include parsley, basil, thyme, oregano, dill, chive, rosemary, sage, tarragon, garlic, fennel, mint, marjoram, lavender, caraway, bay leaf, coriander, cilantro, sorrel, chervil, and combinations thereof. Examples of spices include cinnamon, nutmeg, pepper, salt, ginger, cumin, turmeric anise, cayenne pepper, fenugreek, saffron, cardamom, paprika, allspice, garma masala, garlic, onion, chili pepper, curry, mustard, celery, clove, and combinations thereof.

In some embodiments, the amount of the seasoning component is in a range of about 1 wt % to about 4 wt % of the dry ingredients.

In some embodiments, the amount of the seasoning component is in a range of about 1 wt % to about 2 wt % of the dry ingredients.

Dried Fruit/Veqetables Component

The dry ingredients of the dried meat-containing shaped food product may also comprise a dried fruit/vegetable component that comprises dried fruits and/or vegetables, and/or pieces thereof, wherein the dried fruit/vegetable component is at an amount in a range of about 1 wt % to about 20 wt % of the dry ingredients. Examples of dried fruits and vegetable include apple, cherry, pineapple, lemon, lime, melon, avocado, strawberry, blueberry, raspberry, black berry, currant, pear, banana, plum, quince apricot, fig, grape, peach, orange, grapefruit, kiwi, goji, acai, pomegranate, dragon fruit, mangosteen, soursop, noni, celery, cauliflower, broccoli, cucumber, beet, spinach, corn, onion, leek, shallot, artichoke, pumpkin, kale, zucchini, radish, cabbage, carrot, pepper, jalapeno, potato, turnip, parsnip, asparagus, eggplant, Brussel sprout, tomato, pea, mushroom, and combinations thereof.

In some embodiments, the amount of the dried fruit/vegetable component is in a range of about 2 wt % to about 16 wt % of the dry ingredients.

In some embodiments, the amount of the dried fruit/vegetable component is in a range of about 5 wt % to about 10 wt % of the dry ingredients.

Crisped Grain Component

The dry ingredients of the dried meat-containing shaped food product may also comprise a crisped grain component at an amount in a range of about 2 wt % to about 25 wt % of the dry ingredients Examples of the crisped grain component include crisps of rice, pea, chia, quinoa, sorghum, amaranth, flaxseed, oat, beans, lentils, and combinations thereof.

Cereal Grain Component

The dry ingredients of the dried meat-containing shaped food product may also comprise a cereal grain component that comprises cereal grains in a form selected from the group consisting of whole grain, hulled grain, flaked grain, rolled grain, cut grain, and combinations thereof, wherein the amount of the cereal grain component is in a range of about 2 wt % to about 25 wt % of the dry ingredients. Examples of cereal grains include oats, wheat, rice, sorghum, and combinations thereof.

### Binder

As indicated above, the binder adheres the dry ingredients together resists the migration of moisture between the dry ingredients thereby providing the food product a shelf-stable structure and the solid nut component a shelf-stable, dry-crunchy texture.

The dried meat-containing shaped food product comprises a binder at an amount in a range of about 10 wt % to about 40 wt % of the food product.

In some embodiments, the amount of the binder is in a range of about 15 wt % to about 25 wt % of the food product.

In some embodiments, the amount of the binder in a range of about 20 wt % to about 22 wt % of the food product.

Saccharide Syrup Component

To achieve the desired structural and textural stabilities, the binder comprises an effective amount of a saccharide syrup component having a Brix of at least 80. In one embodiment, the saccharide syrup component has a Brix of about 88. In one embodiment, the saccharide syrup component has a Brix of about 88. Such a saccharide syrup component may be produced, for example, by cooking honey having a Brix of about 81 until the desired Brix level (e.g., 88) is achieved, which may take about 30 minutes.

In contrast, it has been observed that if the binder has a Brix of less than 80, a bar formed using the binder the solids tend to separate over time and the binder puddles. Further, a baked slab made with a low Brix tends to fall apart upon being cut into bars and in some instances the binder pools on the bottom of the slab and bars cut therefrom. Also, such bars tend to be sticky and wet making then unpleasant to hold when eating.

In some embodiments, the saccharide syrup component comprises a sweetener syrup, a fiber syrup, or a combination of a sweetener syrup and a fiber syrup. Examples of sweetener syrup include simple syrup, cane syrup, rice syrup, tapioca syrup, honey, sweet potato syrup, pea syrup, corn syrup, and combinations thereof. An exemplary fiber syrup is one that comprises inulin.

Results to date indicate that the an effective amount of the saccharide syrup component within the binder is in a range of about 50 wt % to 100 wt % of the binder and the total amount of all the other components included in the binder are in a range of 0 wt % to about 50 wt %.

In other embodiments, the binder comprises the saccharide syrup component at an amount in a range of about 55 wt % to about 80 wt % of the binder and the total amount of all the other components included in the binder are in a range of about 20 wt % to about 45 wt %.

In other embodiments, the binder comprises the saccharide syrup component at an mount in a range of about 60 wt % to about 70 wt % of the binder and the total amount of all the other components included in the binder are in a range of about 30 wt % to about 40 wt %.

Starch Component

In some embodiments, the binder further comprises a starch component. In such embodiments, the starch component is at an amount in a range of about 1 wt % to about 30 wt % of the binder. Examples of starches suitable for the starch component include one or more starches from sources selected from the group consisting of corn, wheat, pea, oat, and rice.

In some embodiment, the amount of the starch component is in a range of about 3 wt % to about 15 wt % of the binder.

Results to date indicate that inclusion of the starch component tends to reduce the flow of the a dried meat-containing shaped food product during a baking preparation method (see below). Additionally, it has been observed that inclusion of the starch component tends to decrease the sweetness of the dried meat-containing shaped product without significantly changing the texture of the dried meat-containing shaped product.

Protein Powder Component

In some embodiments, the binder further comprises a protein component. In such embodiments, the protein powder component is at an amount in a range of about 1 wt % to about 25 wt % of the binder. Examples of protein powders suitable for the protein component include one or more of protein powders from sources selected from the group consisting of whey, egg, soy, pea, rice milk, and legume. Typically, such protein powders have a protein content in a range of about 50 wt % to about 80 wt %.

In some embodiment, the amount of the protein powder component is in a range of about 3 wt % to about 10 wt % of the binder.

Results to date indicate that inclusion of the protein component tends to reduce the flow of the a dried meat-containing shaped food product during a baking preparation method (see below). Additionally, it has been observed that inclusion of the protein component tends to impart an umami flavor to the dried meat-containing shaped product. Further, it has been observed that inclusion of the protein component tends to impart a slight springiness to the texture of the dried meat-containing shaped product.

Nut Butter Component

The binder of the dried meat-containing shaped food product may also comprise a nut butter component that comprises one or more pastes of seeds, nuts, legumes, and/or combinations thereof, wherein the amount of the nut butter component is in a range of about 1 wt % to about 20 wt % of the binder. Examples of seeds of the nut butter component include pumpkin, sesame, sunflower, watermelon, poppy, flax, quinoa, hemp, chia, pomegranate, pine nut, and combinations thereof. Examples of nuts and legumes of the nut butter component include peanut, cashew, almond, pistachio, walnut, pecan, Brazil nut, hazelnut, chestnut, macadamia, coconut, pine nut, chickpea and combinations thereof.

Oil Component

The binder of the dried meat-containing shaped food product may also comprise an oil component at an amount in a range of about 0.5 wt % to about 5 wt % of the binder. Examples of oils that may be included in the oil component include sesame oil, coconut oil, olive oil, canola oil, and combinations thereof.

Results to date indicate that the addition of oil tends to increase the likelihood that a food product is perceived to have a moist texture despite the above-described relatively low water activity, a_{w}, of the food product. Advantageously, this perception of a moist texture is accompanied by little to no decrease in the crunchiness of the solid nut component or the crispiness of crisped grain component.

### Topical Ingredients

The dried meat-containing shaped food product may comprise one or more topical ingredients applied to one or more surfaces of the food product. Examples of topical ingredients include jerky, nuts, candy, seeds, dried fruit, dried vegetables and pieces thereof; salt, herbs, and spices; chips (e.g., chocolate chips); compound coating pieces (e.g., pieces of white chocolate coating or yogurt coating); caramel; and combinations thereof.

### Coatings

The dried meat-containing shaped food product may comprise a coating applied to one or more surfaces of the food product. Examples of coating include chocolate coating, compound coating (e.g., white chocolate coating or yogurt coating), fruit (paste or leather) layer, caramel, and combinations thereof.

### Preparation of the Dried Meat-Containing Shaped Food Product

Bake Method

The dried meat-containing shaped food product may be prepared by any appropriate method. In one embodiment, the food product is prepared by a method that involves baking. More specifically, said method comprises forming a mixture that comprises dry ingredients (in accordance with any of the above-described embodiments) at an amount in the range of about 10 wt % to about 25 wt % of the mixture. For example, in one embodiment, the dry ingredients comprise: (i) a dried meat component comprising pieces dried meat, wherein the dried meat component is at amount in the range of about 10 wt % to about 50 wt % of the dry ingredients; and (ii) a solid nut component comprising seeds, nuts and/or legumes, and/or pieces thereof, wherein the solid nut component is at an amount in the range of about 25 wt % to about 90 wt % of the dry ingredients. Additionally, the mixture comprises a binder (in accordance with any of the above-described embodiments) at an amount in the range of about 10 wt % to about 30 wt % of the food product. For example, in said embodiment, the binder comprises a saccharide syrup component and has a Brix of at least 80. To facilitate the mixing, it may be desirable to control the temperature of the binder so that it is in a range of about 85 to about 90 when forming the mixture. The method further comprises shaping the mixture and baking the shaped mixture, or baking the mixture and shaping the baked mixture. The baking results in the binder adhering the dry ingredients together and resisting the migration of moisture between the dry ingredients, thereby resulting in the dried meat-containing shaped food product. The resulting dried meat-containing shaped food product has a water activity, a_{w}, that is in a range of 0.35-0.69, a shelf-stable structure, and a shelf-stable dry-crunchy texture. In one embodiment, the baking in controlled so that the mixture reaches a temperature of at least about 195° F. (91° C.) for at least about 2 minutes.

### No Bake Method

In one embodiment, the food product is prepared by a method that does not involve baking. More particularly, a similar texture to that obtained via baking as described above may achieved by cooking the syrup to a brix at or above 94 brix. Cooking syrup to this brix is challenging, especially at a large, commercial scale, because it requires a great deal of energy to heat the syrup and time to allow the syrup to concentrate. Also, syrup this hot can be dangerous and difficult to handle. Further, a dough made with such a high brix syrup may require its processing to be completed more quickly. For example, such a dough may require being sheeted and formed (e.g., into bars, clusters, or balls) before the syrup cools any significant amount because if it cools significantly it may not be formable in conventional operations. In contrast, cooking the syrup to a lower brix and then baking allows products to be made with less energy and syrup cooking time and easier processing. Additionally, products created using a high brix syrup may have more brittle texture that may result in the product breaking into multiple pieces when bitten or cut.

The no-bake method comprises forming a mixture that comprises dry ingredients (in accordance with any of the above-described embodiments) at an amount in the range of about 10 wt % to about 25 wt % of the mixture. For example, in one embodiment, the dry ingredients comprise: (i) a dried meat component comprising pieces dried meat, wherein the dried meat component is at amount in the range of about 10 wt % to about 50 wt % of the dry ingredients; and (ii) a solid nut component comprising seeds, nuts and/or legumes, and/or pieces thereof, wherein the solid nut component is at an amount in the range of about 25 wt % to about 90 wt % of the dry ingredients. Additionally, the mixture comprises a binder (in accordance with any of the above-described embodiments) at an amount in the range of about 10 wt % to about 30 wt % of the food product. For example, in said embodiment, the binder comprises a saccharide syrup component and has a Brix of at least 94. To facilitate the mixing, it may be desirable to control the temperature of the binder so that it is in a range of about 200° F. (93° C.) to about 250° F. (121° C.) when forming the mixture. The method further comprises shaping the mixture thereby resulting in the dried meat-containing shaped food product, wherein in the binder adheres the dry ingredients together and resists the migration of moisture between the dry ingredients. The resulting dried meat-containing shaped food product has a water activity, a_{w}, that is in a range of 0.35-0.69, a shelf-stable structure, and a shelf-stable dry-crunchy texture.

### EXAMPLES

### Example 1—Baked Peppered Jerky Bar

| Ingredient | Percent |
|---|---|
| Almonds, dry roasted, | 43.59% |
| unsalted | |
| Honey, Amber, Light | 6.90% |
| Oligofructose (chicory root | 18.18% |
| fiber) | |
| Salt | 0.24% |
| Peppered Beef Jerky | 16.30% |
| Black Pepper | 0.50% |
| White Pepper Cracked | 0.50% |
| Pepitas, roasted, unsalted | 13.79% |
| Total | 100.00% |

### Directions:

Weigh out dry ingredients and mix together
Weigh out binder ingredients and mix together
Heat binder to desired brix/temperature—132° C.
Weigh amount of desired brix binder into dries and mix together to form a mixture (dough)
Sheet out mixture (dough) onto a pan
Bake sheeted dough in oven—149° C. for 15 minutes
Remove baked bar from oven and allow to cool
Cut cooled bar into desired shape/size/weight

### Example 2—Baked Italian Rosemary Oregano Jerky Bar

| Ingredient | Percent |
|---|---|
| Almonds, dry roasted, | 23.59% |
| unsalted | |
| Pine Nuts, roasted, | 20.05% |
| unsalted | |
| Honey, Amber, Light | 6.90% |
| Oligofructose (chicory | 18.18% |
| root fiber) | |
| Salt | 0.24% |
| Garlic Powder | 0.30% |
| Rosemary | 0.25% |
| Oregano | 0.25% |
| Beef Jekry | 16.30% |
| Black Pepper | 0.15% |
| Pepitas, roasted, | 13.79% |
| unsalted | |

### Directions:

weigh out dry ingredients and mix together;
weigh out binder ingredients and mix together;
heat binder to desired brix/temperature—88 brix;
weigh amount of desired brix binder into dries and mix together to form a mixture (dough);
sheet out mixture (dough) onto a pan;
bake sheeted dough in oven—149° C. for 13 minutes;
remove baked bar from oven and allow to cool; and
cut cooled bar into desired shape/size/weight.

### Example 3—Baked Jalapeno Siracha Jerky Bar

| Ingredient | Percent |
|---|---|
| Almonds, dry roasted, unsalted | 18.00% |
| Peanuts, dry roasted, unsalted | 6.00% |
| Honey, Amber, Light | 19.07% |
| Brown Rice Syrup 60DE 81BX | 14.24% |
| Salt | 0.22% |
| Soy Crisp 80% Protein (NG) | 15.00% |
| Beef Jerky | 14.00% |
| Freeze Dried Corn | 0.67% |
| Freeze Dried Jalpeno | 0.56% |
| Srirachia Seasoning | 0.17% |
| Hemp Seeds (shelled) | 2.02% |
| Pepitas, roasted, unsalted | 10.05% |

### Directions:

weigh out dry ingredients and mix together;
weigh out binder ingredients and mix together;
heat binder to desired brix/temperature—89 brix;
weigh amount of desired brix binder into dries and mix together to form a mixture (dough);
sheet out mixture (dough) onto a pan;
bake sheeted dough in oven—177° C. for 14 minutes;
remove baked bar from oven and allow to cool; and
cut cooled bar into desired shape/size/weight.

Sensory Testing Protocol involves the following:
evaluators wash hands before testing;
evaluators are disqualified for testing if suffering from an illness affecting the ability to taste or smell (e.g., a cold, congestion, flu, etc.);
evaluators are not allowed to wear perfumes or aftershave compositions;
evaluation room is free of noise and odor;
evaluators are not alled to smoke less than 30 minutes for conducting an evaluation;
evaluators are not allowed to talk during an evaluation; and
evaluators are not allowed to discuss results with other evaluators of an evaluation until every evaluator is finished.
   The Sensory Testing Protocol involves evaluating appearance, taste/flavor, aroma, sound, and texture.

Flavor

The following are the four types of taste/flavor which may be used by the evaluators:
Sweet—typically induced by disaccharides, mediated by receptors in taste buds at the front of the tongue;
Salty—of, seasoned with, or containing salt;
Bitter—acrid, astringent or disagreeable, and suggestive of an infusion of hops; and
Sour (or Tartness)—taste sensations produced chiefly by acids.

The protocol involves a basic taste recognition test wherein cups of containing a sample with a dominant taste (i.e., Sweet, Salty, Bitter, and Sour) along with water are presented for tasting and characterization. Evaluators must be able to correctly identify the dominant tastes.

Appearance

Involves evaluating Color characteristics, Surface characteristics, and Shape/Size. Evaluating Color involves characterizing Hue (e.g., red, green, brown, etc.), Intensity (e.g., light to dark), and Chroma (i.e., clarity of color such as mottled and, speckled). Evaluating Surface involves characterizing Shine (e.g. dull to shiny), Roughness (smooth to rough), Uniformity of the Shine and Roughness across the surface of the sample.

The protocol involves a basic color recognition test, typically the Ishihara test for red-green color deficiencies. Evaluators that are colorblind for red may not evaluate samples with red hues in it.

Aroma

In general, aromas/odors may be described as having one or more of a variety of characteristics such as the following: sweet, nutty, savory, chocolate, caramel, cereal, meaty, etc. Further, it has been found that it is preferable for a dried meat-containing shaped food product to have an aroma profile that comprises the following characteristics: sweet, nutty, cereal, and meaty.

The protocol involves a basic aroma recognition test wherein cups of containing a sample with a dominant aroma characteristic are presented for characterization. Evaluators are instructed to open each cup one at a time and to take short, shallow sniffs, not to put his/her nose into the cup. Evaluators must be able to correctly identify the dominant aromas.

Sound

The protocol involves listening while biting and chewing a food product. Particularly relevant sounds are those corresponding to crispiness, which is reflected by relatively high pitch sounds when biting and chewing, and crunchiness, which is reflected by a relatively low pitch sounds when biting and chewing.

Texture

The protocol involves considering and evaluating the following characteristics while visualizing, handling, and eating the food product: Mechanical characteristics (i.e., characteristics related to the reaction of the food product to stress (e.g., hardness), Geometrical characteristics (i.e., the arrangement of physical constituents of a food product such as shape, size, and arrangement of particles within the food product (e.g., particle size), and Other characteristics such as the degree of melt, moisture, fat, roughness, smoothness when chewing, feel on the tongue.

In or Out of Specification Test Method

The protocol also involves providing the evaluators of standards in the form of written descriptions, photographs, and physical specimens so the evaluators may be trained and aware of whether certain characteristics of food products are in or out of an acceptable, specified range or state (i.e., Specification). By using an in or out of Specification evaluation method, subjectivity may be reduced or even eliminated and it makes conducting the evaluation much simpler.

### Example 4—Sensory Testing

| Ingredient | Percent |
|---|---|
| Almonds, whole | 40.13 |
| Honey, Light Amber | 5.13 |
| Oligiofructose | 15.38 |
| Crisp | 7.50 |
| Jerky | 16.30 |
| Pepper seasoning | 1.60 |
| Pepitas | 13.96 |
| Total | 100 |

### Bar Preparation Directions:

weigh out dry ingredients and mix together;
weigh out binder ingredients and mix together;
heat binder to desired brix/temperature—89 brix;
weigh amount of desired brix binder into dries and mix together to form a mixture (dough);
sheet out mixture (dough) onto a pan;
bake sheeted dough in oven—177° C. for 14 minutes;
remove baked bar from oven and allow to cool;
cut cooled bar into desired shape/size/weight;
packed bars in metalized film wrap; and
place bars in ambient storage conditions and accelerated storage conditions (32.2° C.).

Sample bars were evaluated every two and one-half weeks by three or four persons with sensory attribute training. The sensory evaluations occurred six times over 18 weeks. One week at accelerated storage conditions (32.2° C.) is equal to 1 month of ambient storage.

Sensory evaluators evaluated the bars for appearance, aroma, flavor, and texture and rated the bars according to the following scale: green corresponding to “acceptable”, yellow corresponding to “acceptable with reservations”, and red corresponding to “unacceptable.”

Approximately 576 sensory data points were collected. There were no red data points, 11 yellow (approximately: 1.9%), and the remaining were green. Yellow data points resulted from, slight decrease in flavor, a firm initial bite texture and a chewy meat texture. These results (i.e., about 98% acceptable) show that the bars will be acceptable texture and taste over 12 months.

### Example 5—Inclusion of Starch Component in Binder

| Ingredient | Percent |
|---|---|
| Almonds, dry roasted, unsalted | 33.88% |
| Honey, Amber, Light | 4.63% |
| Oligofructose (chicory root fiber) | 13.88% |
| Starch (corn, pea, and wheat) | 8.00% |
| Salt | 0.24% |
| Beef Jerky | 21.00% |
| Pumpkin Seeds | 11.96% |
| Salt | 0.64% |
| Crisps | 6.00% |
| Total | 100.00% |

### Bar Preparation Directions:

weigh out dry ingredients and mix together;
weigh out binder ingredients and mix together;
heat binder to desired brix/temperature—116° C.;
weigh amount of desired brix binder into dries and mix together to form a mixture (dough);
sheet out mixture (dough) onto a pan;
bake sheeted dough in oven—182° C. for 12 minutes;
remove baked bar from oven and allow to cool; and
cut cooled bar into desired shape/size/weight.

It was observed that there was less spread of the dough during the bake compared to doughs not containing the starch component. It was also observed that these bars were less sweet than bars not containing the starch component but the texture was substantially the same as bars not containing the starch component. Further, it was observed that the these bars exhibited less syrup “seep” or migration toward the base of the bars.

### Example 6—Inclusion of Protein Component in Binder

| Ingredient | Percent |
|---|---|
| Almonds, dry roasted, unsalted | 34.88% |
| Honey, Amber, Light | 4.88% |
| Oligofructose (chicory root fiber) | 14.63% |
| Protein Powder (whey and egg) | 8.00% |
| Salt | 0.24% |
| Beef Jerky | 21.00% |
| Pumpkin Seeds | 13.96% |
| Salt | 0.65% |
| Crisps | 6.00% |
| Total | 100.00% |

### Bar Preparation Directions:

weigh out dry ingredients and mix together;
weigh out binder ingredients and mix together;
heat binder to desired brix/temperature—85° C.;
weigh amount of desired brix binder into dries and mix together to form a mixture (dough);
sheet out mixture (dough) onto a pan;
bake sheeted dough in oven—182° C. for 13 minutes;
remove baked bar from oven and allow to cool; and
cut cooled bar into desired shape/size/weight.

It was observed that there was less spread of the dough during the bake compared to doughs not containing the starch component. It was also observed that these bars had a slight umami flavor and the texture had a little more springiness than bars not containing the protein powder component. Further it was observed that the these bars exhibited less syrup “seep” or migration toward the base of the bars.

Texture Analysis using a TA.XT Plus texture analyzer available from Texture Technologies of 6 Patton Drive, Hamilton, Mass. 01982.

Having illustrated and described the principles of the present invention, it should be apparent to persons skilled in the art that the invention may be modified in arrangement and detail without departing from such principles.

Although the materials and methods of this invention are described in terms of various embodiments and illustrative examples, it will be apparent to those of skill in the art that variations may be applied to the materials and methods described herein without departing from the concept, spirit and scope of the invention. All such similar substitutes and modifications apparent to those skilled in the art are deemed to be within the spirit, scope and concept of the invention as defined by the appended claims.

1-40. (canceled)

41. A dried meat-containing food product, the food product comprising:
(a) dry ingredients at an amount in the range of about 60 wt % to about 90 wt % of the food product, wherein the dry ingredients comprise:
(i) a dried meat component comprising pieces of dried meat or plant protein, wherein the dried meat component is at amount in the range of about 1 wt % to about 55 wt % of the dry ingredients; and
(ii) a solid nut component comprising seeds, nuts and/or legumes, and/or pieces thereof, wherein the solid nut component is at an amount in the range of about 25 wt % to about 90 wt % of the dry ingredients; and
(b) a binder at an amount in the range of about 10 wt % to about 40 wt % of the food product, wherein the binder comprises a saccharide syrup component having a Brix of at least 80, and wherein the binder adheres the dry ingredients together and resists the migration of moisture between the dry ingredients thereby providing:
(i) a shelf-stable structure to the food product, wherein a shelf-stable structure is one in which, at the one-year anniversary of the food product being made and placed in a sealed container or package, the shape of the food product is maintained with the dry ingredients remaining adhered together without separation of the binder and the dry ingredients; and
(ii) a shelf-stable, dry-crunchy texture to the solid nut component, wherein the shelf-stable, dry-crunchy texture is one in which, at the one-year anniversary of the food product being made and placed in a sealed container or package, the food product has a water activity, a_{w}, that is in a range of about 0.35 to about 0.69.

42. The dried meat-containing food product of claim 41, wherein:
the a_{w} of the food product is in a range of about 0.40 to about 0.65;
the amount of the binder is in the range of about 15 wt % to about 25 wt % of the food product;
the amount of the dried meat component is in the range of about 10 wt % to about 50 wt % of the dry ingredients;
the amount of the solid nut component is in the range of about 35 wt % to about 80 wt % of the dry ingredients; and
the saccharide syrup component is at an amount in a range of about 50 wt % to 100 wt % of the binder.

43. The dried meat-containing food product of claim 41, wherein:
the a_{w} of the food product is in a range of about 0.50 to about 0.60;
the amount of the binder in the range of about 20 wt % to about 22 wt % of the food product;
the amount of the dried meat component is in the range of about 10 wt % to about 30 wt % of the dry ingredients;
the amount of the solid nut component is in the range of about 45 wt % to about 70 wt % of the dry ingredients; and
the saccharide syrup component is at an amount in a range of about 55 wt % to about 80 wt % of the binder.

44. The dried meat-containing food product of claim 41, wherein the saccharide syrup component comprises a sweetener syrup, a fiber syrup, or a combination of a sweetener syrup and a fiber syrup, wherein:
the sweetener syrup is selected from the group consisting of cane syrup, rice syrup, tapioca syrup, honey, sweet potato syrup, pea syrup, corn syrup, and combinations thereof; and
the fiber syrup comprises inulin.

45. The dried meat-containing food product of claim 41, wherein the solid nut component comprises:
nuts and/or legumes, and/or pieces thereof at an amount in the range of about 20 wt % to about 80 wt % of the dry ingredients; and
seeds and/or pieces thereof at an amount in the range of 5 wt % to about 50 wt % of the dry ingredients.

46. The dried meat-containing shaped food product of claim 41, wherein the solid nut component comprises:
nuts and/or legumes, and/or pieces thereof at an amount in the range of about 40 wt % to about 55 wt % of the dry ingredients; and
seeds and/or pieces thereof at an amount in the range of about 5 wt % to about 15 wt % of the dry ingredients.

47. The dried meat-containing food product of claim 41, wherein the dry ingredients further comprise one of more of the following:
a seasoning component comprising particles selected from the group consisting of salt, herbs, spices, and combinations thereof, wherein the seasoning component is at amount in the range of about 0.5 wt % to about 6 wt % of the dry ingredients;
a dried fruit/vegetable component that comprises dried fruits and/or vegetables, and/or pieces thereof, wherein the dried fruit/vegetable component is at an amount in a range of about 1 wt % to about 20 wt % of the dry ingredients;
a crisped grain component at an amount in a range of about 2 wt % to about 25 wt % of the dry ingredients; and
a cereal grain component that comprises cereal grains in a form selected from the group consisting of whole grain, hulled grain, flaked grain, rolled grain, cut grain, and combinations thereof, wherein the amount of the cereal grain component is in a range of about 2 wt % to about 25 wt % of the dry ingredients.

48. The dried meat-containing food product of claim 41, wherein the binder further comprises one or more of the following:
a starch component at an amount in a range of about 1 wt % to about 30 wt % of the binder;
a protein powder component at an amount in a range of about 1 wt % to about 25 wt % of the binder;
a nut butter component that comprises one or more pastes of seeds, nuts, legumes, and/or combinations thereof, wherein the amount of the nut butter component is in a range of about 1 wt % to about 20 wt % of the binder; and
an oil component at an amount in a range of about 0.5 wt % to about 5 wt % of the binder.

49. The dried meat-containing food product of claim 48, wherein:
the starch component comprises one or more starches from sources selected from the group consisting of corn, wheat, pea, oat, and rice; and
the protein powder component comprises one or more protein powders from sources selected from the group consisting of whey, egg, soy, pea, rice milk, and legume.

50. The dried meat-containing food product of claim 41, further comprising one or more topical ingredients applied to one or more surfaces of the food product, wherein the topical ingredients are selected from the group consisting of jerky, nuts, candy, seeds, dried fruit, dried vegetables, and pieces thereof, salt, herbs, spices, chocolate chips, compound coating pieces, caramel pieces, and combinations thereof.

51. The dried meat-containing food product of claim 41, further comprising a coating applied to one or more surfaces of the food product, wherein the coating is selected from the group consisting of chocolate coating, compound coating, yogurt coating, fruit layer, caramel, and combinations thereof.

52. A method of making a dried meat-containing shaped food product, the method comprising:
forming a mixture that comprises:
(a) dry ingredients at an amount in the range of about 60 wt % to about 90 wt % of the mixture, wherein the dry ingredients comprise:
(i) a dried meat component comprising pieces dried meat, wherein the dried meat component is at amount in the range of about 1 wt % to about 55 wt % of the dry ingredients; and
(ii) a solid nut component comprising seeds, nuts and/or legumes, and/or pieces thereof, wherein the solid nut component is at an amount in the range of about 25 wt % to about 90 wt % of the dry ingredients; and
(b) a binder at an amount in the range of about 10 wt % to about 40 wt % of the food product, wherein the binder comprises a saccharide syrup component and has a Brix of at least 80; and
shaping the mixture thereby resulting in the dried meat-containing food product, wherein the binder adheres the dry ingredients together and resists the migration of moisture between the dry ingredients, wherein:
the food product has a shelf-stable structure, wherein a shelf-stable structure is one in which, at the one-year anniversary of the food product being made and placed in a sealed container or package, the shape of the food product is maintained with the dry ingredients remaining adhered together without separation of the binder and the dry ingredients; and
the solid nut component has a shelf-stable, dry-crunchy texture, wherein the shelf-stable, dry-crunchy texture is one in which, at the one-year anniversary of the food product being made and placed in a sealed container or package, the food product has a water activity, a_{w}, that is in a range of about 0.35 to about 0.69.

53. The method of claim 52 further comprising having the binder at a temperature in a range of about 200° F. (93° C.) to about 250° F. (121° C.) when forming the mixture.

54. The method of claim 52 further comprising baking the mixture before or after the shaping of the mixture.
